(19) United States
(12) Patent Application Publication
(10) Pub. No.: US 2007/0206605 A1
(43) Pub. Date: Sep. 6, 2007

(54) Autonomous System-Based Edge Marking (ASEM) For Internet Protocol (IP) Traceback

(75) Inventors: Nirwan Ansari, Montville, NJ (US); Zhiqiang Gao, Westfield, NJ (US)

Correspondence Address: CONNOLLY BOVE LODGE & HUTZ LLP, 1875 EYE STREET, N.W., SUITE 1100, WASHINGTON, DC, 20036, US

(73) Assignee: New Jersey Institute of Technology, Newark, NJ (US)

(21) Appl. No.: 11/680,837

(22) Filed: Mar. 1, 2007

Related U.S. Application Data
(60) Provisional application No. 60/778,141, filed on Mar. 1, 2006.

(51) Int. Cl. H04L 12/28

(52) U.S. Cl. 370/395.5

(57) ABSTRACT

Embodiments are directed to an Autonomous System-based Edge Marking (ASEM) for Internet Protocol (IP) traceback. In particular, the embodiments are a system and a method for IP traceback that receives one or more packets at routers; inscribes packets only at marking routers with autonomous system (AS) level and marking information; and forwards the marked packets to edge routers and other routers for verification. Additionally the packets are marked based on a probability measure and Border Gateway Protocol (BGP) routing table information is the AS level information used for marking and verification.

### DESCRIPTION OF BACKGROUND ART

The ubiquitous Internet has significantly altered our way of living. Daily activities (e.g., online-banking, stock trading and teleconferencing) increasingly rely on the performance of the Internet. Network security for military communications and financial transactions on the Internet is a particularly big concern. The advent of the lethal Denial of Service (DoS) attack and its advanced variant, the Distributed DoS (DDoS) attack are troublesome intruders on our usage and dependence on the Internet. The detrimental impact of DoS/DDoS attacks has been demonstrated again and again, even on such high-profile sites as Yahoo, CNN, Ebay and Amazon.

In particular, DDoS attacks impose serious threats to network security. In a DDoS attack, an attacker sends a large volume of malicious traffic to a victim. For example, a DDoS attacker may infiltrate one or a plurality of computers at various data centers via a computer system connected to the Internet. Often the attacker will access the Internet through an Internet Service Provider (ISP). The attacker can then place the plurality of computers at the data centers under its control by use of a malicious software program. When the attacker issues a command, these computers can simultaneously send out large volumes of data at various times to the victim preventing the victim from responding to legitimate Internet traffic and messages.

Internet Protocol (IP) traceback schemes are used to combat DDoS. IP traceback schemes include any method for reliably determining the origin of a packet on the Internet. However, the datagram nature of the Internet makes it difficult to determine the originating host of a packet because the source identification supplied in an IP packet can be falsified (i.e., IP spoofing) for the DDoS attacks discussed above.

IP traceback attempts to trace attack flows from the target (i.e., the victim) back to the possibly disparate sources used by the attacker. To elude possible penalties and achieve better attack effects, the attacker assaults the victim from hundreds of zombies (i.e., subverted hosts) rather than from their own machine. Second, attack traffic from many zombies will aggregate at the victim. Therefore, it is very hard, if not impossible, for the victim to distinguish malicious traffic from the legitimate traffic on the Internet.

The deficiencies of background art IP traceback schemes include, but are not limited to: heavy computational burdens, high false alarm rates, and scalability. At least for the above-discussed reasons, background art IP traceback schemes are inefficient and often impractical. Therefore, improvements in the art of IP traceback are needed to identify sources of DDoS attacks and institute protection measures for the Internet.

### SUMMARY

Embodiments are directed at overcoming the foregoing and other difficulties encountered by the background arts. In particular, embodiments provide a method that would effectively and robustly trace thousands of attack sources within a very short time and with low complexity.

### BRIEF DESCRIPTION OF THE DRAWINGS

FIG. 1 is an exemplary system diagram of an embodiment of Autonomous System-based Edge Marking (ASEM) with AS paths vs. hop-by-hop paths.

FIG. 2 is an exemplary system diagram and embodiment of ASEM with a prefix originated ASPATH attribute.

FIG. 3 is an exemplary flow diagram for a method of marking at the first marking router of an embodiment of ASEM.

FIG. 4 is an exemplary flow diagram for a method of marking and verification algorithms for routers of an embodiment of ASEM.

FIG. 5 is an exemplary graph of analysis results of Nⱼ for PPM vs. for a first advantage of embodiments of ASEM over the background art.

FIG. 6 is an exemplary graph of analysis results of Nⱼ for PPM vs. showing a second advantage of embodiments of ASEM over the background art.

FIG. 7 is an exemplary graph of analysis results of Nⱼ for PPM vs. embodiments of ASEM showing the integration of a first and second advantage over the background art.

### DETAILED DESCRIPTION

Embodiments include, but are not limited to an Autonomous System-based Edge Marking (ASEM) for Internet Protocol traceback. On the Internet, an autonomous system (AS) is a collection of Internet Protocol (IP) networks and routers under the control of one or more entities that presents a common routing policy to the Internet. An Internet Protocol (IP) is a data-oriented protocol used for communicating data across a packet-switched internetwork.

Embodiments of ASEM have been optimized through such that the heavy computational burden and high false alarm rates of the background art can be reduced. In addition, in contrast to the background art, embodiments are more robust to IP spoofing and subverted routers. Embodiments simplify the tracing procedure relative to the background art because: (1) with linkage information, path reconstruction can be completed promptly and correctly; and (2) far fewer packets are required to locate an attack source.

Embodiments provide a novel marking scheme for IP traceback at the Autonomous System (AS) level and, as discussed above, are referred to as AS-based Edge Marking (ASEM) for IP traceback. Background art IP traceback schemes such as disclosed in M. Goodrich, Efficient packet marking for large-scale IP traceback, in: 9^{th} ACM conf. on computer and communications security, 2002, pp. 117-126, use IP address information of each router to reconstruct the attack paths, hop-by-hop.

Similar to the background art IP traceback scheme referred to as Probabilistic Packet Marking (PPM), in embodiments of ASEM for, routers along the attack paths mark packets according to a certain probability. However, in contrast to the background art, advantages of the ASEM method over the PPM include, but are not limited to: (1) only the ingress edge routers of each AS conduct marking; (2) all routers are prohibited from re-marking packets already marked by any upstream router; and (3) the marking information is the AS number (ASN) rather than the IP address of each traversed router.

Further, ASEM greatly relieves the victim from the overwhelming computational burden. To quantify this advantage of ASEM, our analysis uses a metric—the number of marked packets required for path reconstruction—to evaluate disparate traceback schemes. Using this metric in the experimental examples below as the guideline, two different methods to mitigate the computational overhead are compared.

The advantages of ASEM discussed above not only reduce the number of packets needed for reconstruction, but also completely eradicate the threat of spoofed marking inscribed by the attacker. Further, ASEM can address spoofed marking incurred by subverted routers by allowing ingress edge routers in the downstream ASs to examine the correctness of the marking information from their adjacent ingress edge routers in the upstream ASs. Furthermore, false positives are effectively suppressed and embodiments of ASEM outperform PPM in that ASEM for IP traceback can handle large-scale DDoS attacks. Moreover, the power-law relationship of the Internet renders embodiments of ASEM effective even under partial deployment.

In embodiments of ASEM, path length is defined as the number of routers eligible to conduct marking in between the attack sources and the victim. Note that, in PPM, all routers along an attack path can mark packets passing by, and therefore all routers along the path are eligible. In contrast, in embodiments of ASEM, only ingress edge routers of each AS are allowed (i.e., are eligible) to perform marking and the path length in our scheme is at the AS level rather than hop-by-hop as in PPM.

Embodiments for ASEM can be developed by noting the Internet hierarchy is rarely used in IP traceback. Autonomous systems (ASs) are an important component of that Internet hierarchy. Normally, an AS is regulated by one entity, which can enforce a consistent routing policy inside the whole administrative domain. However, among different ASs, the administrative policy may be dramatically distinct.

Border Gateway Protocol (BGP) is the core routing protocol of the Internet. In particular, BGP routing is the de facto standard for inter-AS routing. BGP works by maintaining a table of IP networks or ‘prefixes’ which designate network reachability among autonomous systems. A unique AS number (ASN) is allocated to each AS for use in BGP routing. With BGP, AS numbers are important because the ASN uniquely identifies each network on the Internet. Multiple autonomous systems (ASs) depend on BGP to exchange the route reachable information, and this task is conducted by a few routers called BGP Speakers. Three advantageous characteristics of AS with BGP routing are described in the following paragraphs.

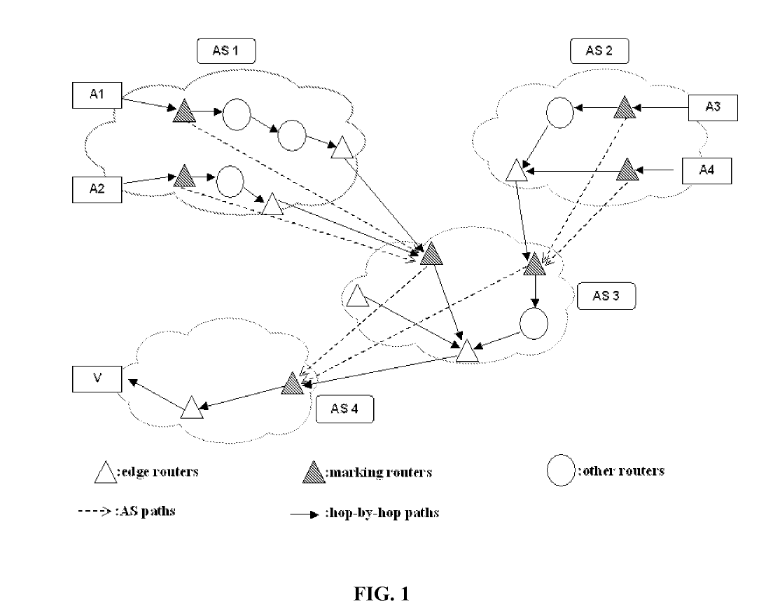

As shown in FIG. 1, multiple autonomous systems AS1, AS2, AS3, AS4 are subject to attackers A1, A2, A3, A4 and have a victim V. Edge routers, marking routers, other routers, AS paths and hop-by-hop paths are indicated by the symbols shown in the legend of FIG. 1. The first advantageous characteristic of ASs is that an AS path is much shorter than the corresponding IP path. For example, as shown in FIG. 1, the attack IP path from A1 takes 8 hops, and the one from A2 takes 7 hops to reach the victim V. In contrast, the attack AS paths are only 3 “hops” in each case.

The above example also illustrates the second advantageous characteristic of ASs in that routing hops at the AS level are much more stable in path length. That is, 3 “hops” was the path length for the AS level paths in each case whereas opposed to 8 and 7 “hops,” were needed in the IP level cases.

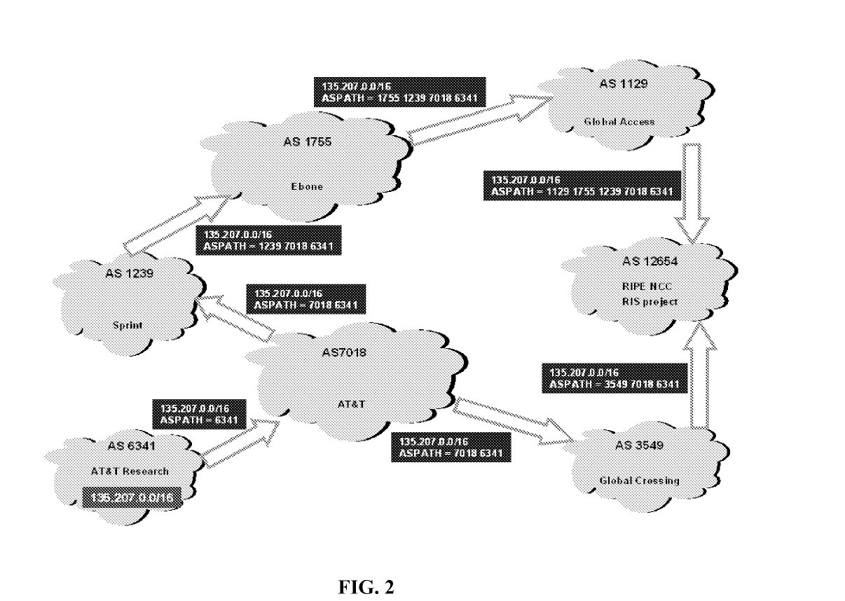

The third advantageous characteristic of ASs with BGP routing is that it generates a message called the ASPATH attribute. The ASPATH provides an ordered list of the ASs traversed before reaching a given destination. FIG. 2 shows multiple autonomous systems AS 1239, AS 1129, AS 1755, AS 3549, AS 6341, AS 7018, AS 12654. An exemplary ASPATH attribute messages is shown in FIG. 2 along with the IP address (i.e., 135.207.0.0/16) which resides in AS 6341. As shown in FIG. 2, suppose that the BGP speaker inside AS 12654 receives two sets of routing information for the IP address prefix 135.207.0.0/16. That is, one set of BGP routing information from AS 1129 to the given destination has the ASPATH attribute “1129 1755 1239 7018 6341” and another set of BGP routing information has the ASPATH attribute “3549 7018 6341.” In addition, since the latter set is shorter, the BGP speaker in AS 12654 may keep the latter ASPATH in its routing table.

The above characteristics implies that: (1) the IP address prefix 135.207.0.0/16 is located inside AS 6341 since the ASPATH attribute ends with “6341”; and (2) packets with destination address in the range of (135.207.0.0, 135.207.255.255) will traverse to AS 7018 via AS 3549, and traverse to AS 6341 via AS 7018 (i.e., assuming that there is not any other prefix inside this range. That is, no prefix such as 135.207.1.0/24 exists in the same BGP routing table).

The above three characteristics are exploited by embodiments of ASEM. The first advantageous characteristic means less “hop” counts from the source to the destination so that a smaller number of marked packets are required for path reconstruction in ASEM. That is, to recover an attack path with ASEM, the victim V needs to receive fewer marked packets with ASEM than with PPM. Thus, ASEM can significantly outperforms background art PPM schemes.

The second characteristic simplifies path reconstruction because fewer paths need to be considered with ASEM. Thus, with ASEM, the victim V is relieved from the problem of combinatorial explosion which is inevitable in the background art PPM scheme.

Finally, when the ASPATH attribute is used for marking, the third characteristic can be used for a simpler marking and marking verification procedures in embodiments of ASEM as compared to background art PPM schemes. That is, the use of BGP routing allows marking information from a downstream marking router R_{b} of AS_{b} (e.g., AS 7018 of FIG. 2) to verify the correctness of the marking embedded by its adjacent upstream marking router Rₐ of ASₐ (e.g., AS 3549 of FIG. 2) because the ASPATH attribute of the upstream marking router Rₐ shall be the concatenation of the ASN of the downstream marking router R_{b} and the ASPATH attribute of the downstream marking router R_{b} (i.e., ASPATH(ASₐ)=Concatenate(AS_{b}, ASPATH(AS_{b})).

For example, as shown in FIG. 2, AS_{b} (AS 7018) is a downstream neighbor of ASₐ (AS 3549). If a mismatch is found, the upstream marking routers can filter or drop those packets with spoofed marking. That is, assume that a path from the source src to the destination dst traverses ASₐ, AS_{b}, AS_{c}, AS_{d}, ASₑ at the AS level. The ASPATH attributes for each AS mentioned above to dst are “AS_{b} AS_{c} AS_{d} ASₑ”, “AS_{c} AS_{d} ASₑ”, “AS_{d} ASₑ”, “ASₑ”, “”, respectively. The use of “” denotes the last AS because the destination dst is inside the last ASₑ where only IGP routing protocol, rather than EGP routing protocol (e.g., BGP), is used.

In embodiments of ASEM, when the ASPATH attribute is used as the marking information at each AS, the marking information from a downstream marking router AS_{b} can be used to verify the correctness of the marking information of the marking router of its upstream neighbor ASₐ. Since only 16 bits are used to store the ASPATH attribute in embodiments of ASEM, we use XOR operation to the ASN of the current AS and all of the ASN in the ASPATH attribute and record the final result in AS_PATH. At the ASₐ upstream marking router, the marking information for dst is ASₐ⊕AS_{b}⊕AS_{c}⊕AS_{d}⊕ASₑ, where ⊕ is the exclusive OR operator; at the downstream marking router AS_{b}, the marking information for dst is AS_{b}⊕AS_{c}⊕AS_{d}⊕ASₑ. Thus, embodiments of ASEM have the relationship AS_PATH(ASₐ)=ASₐ⊕AS_PATH(AS_{b}). This relationship holds for all neighboring ASs.

As an example of the above, suppose a flow of packets are bombarding a host at 135.207.x.y. As shown in FIG. 2, the marking at upstream marking router AS 3549 is then “3549 7018 6341” and the marking at downstream marking router AS 7018 is “7018 6341.” Thus, it is easy for upstream marking router AS 3549 to determine whether the marking information from its downstream neighbor AS 7018 is correct or not (e.g., due to spoofing) because the only difference between the markings of these two ASs should be the AS number (ASN) of the current router AS 3549. Since we only use 16 bits to record the ASPATH attribute, some transformation may be included.

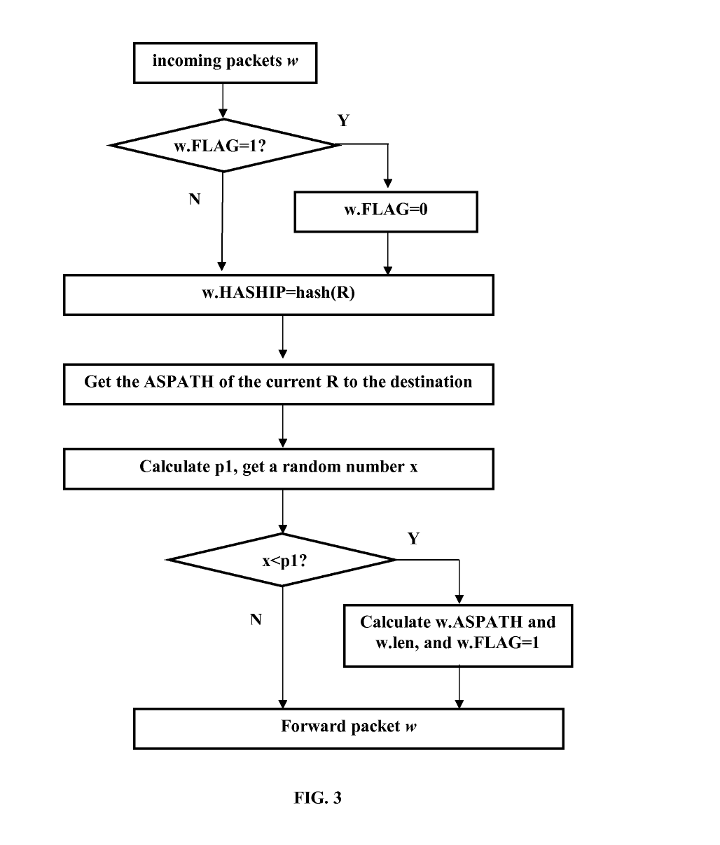

FIG. 3 shows a flow diagram of the pseudo code for a marking procedure at the first ingress edge or marking router R. The pseudo code is given below as:

```
For each packet w
  If w.FLAG=’1’ //the attacker may spoof the flag intentionally
    w.FLAG=’0’
  Write hash(R) into w.HASHIP
  Let dst be the destination IP address of w
  Lookup the BGP routing table of R to get the ASPATH attribute,
  ASPATH_{R}(dst)
```

| | |
|---|---|
| p1=1/(len(ASPATH_{R}(dst))+1) | //the optimal marking |
| | probability of R |
| Let x be a random number from [0,1) | |
| If x<p1 | //mark the packet |
| Write ASN(R) into w.AS_PATH | //initiate AS_PATH with |
| | the current ASN |

```
    For each item u in ASPATH_{R}(dst)
      Write XOR(w.AS_PATH,u) into w.AS_PATH
    Write len(ASPATH_{R}(dst)) into w.LEN
    Write ‘1’ into w.FLAG
  Forward w.
```

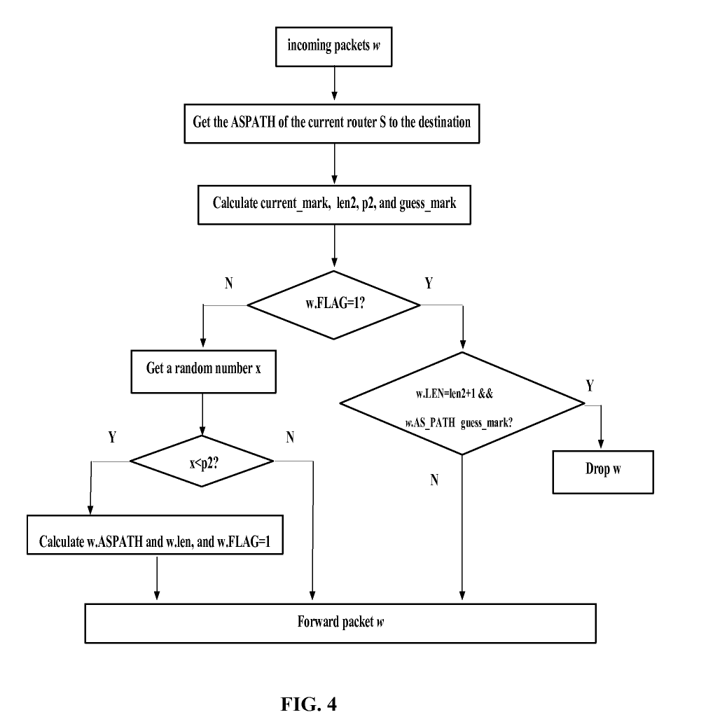

FIG. 4 shows a flow diagram of the pseudo code for a marking and marking verification method at edge and other routers S. The pseudo code is given below as:

| Let dst be the destination IP address of w | |
|---|---|
| Lookup the BGP routing table of S to get the ASPATH attribute, | |
| ASPATH_{S}(dst) | |
| current_mark=ASN(S) | |
| For each item u in ASPATH_{S}(dst) | |
| current_mark=XOR(current_mark, u) | |
| len2=len(ASPATH_{S}(dst)) | |
| p2=1/(len2+1) | //the optimal marking prob. of S |
| guess_mark=XOR(ASN(T),current_mark) | |
| If w.FALG=’1’ | //w has been marked |
| If w.LEN=len2+1 and w.AS_PATH≠guess_mark) | |
| | //spoofed marking from neighbor T |
| Drop w | |
| Else | |
| Forward w | |
| Else | |
| Let x be a random number from [0,1) | |
| If x<p2 | //mark the packet |

```
    Write current_mark into w.AS_PATH
    Write len(ASPATH_{S}(dst)) into w.LEN
    Write ‘1’ into w.FLAG
  Forward w.
```

The following are some assumptions that can be made for embodiments of ASEM:
(1) the attacker may create any packet;
(2) the attacker may know the tracing scheme;
(3) the attack is at least composed of tens of packets;
(4) only a few routers, if any, may be subverted and subverted routers are not adjacent;
(5) every ingress edge router of an AS shares the BGP routing information of its domain;
(6) the AS path is rather stable; and
(7) the length of any AS path is limited.

Assumptions (1) and (2) represent the fact that the attacker may have the root privilege over the zombies, and may generate any packet he/she wants, including spoofed marking intentionally. Assumption (3) indicates that embodiments of ASEM are contrived for flood-based attacks, the dominant DoS/DDoS attack pattern.

In contrast to the background art, embodiments of ASEM address the challenge of spoofed marking from both the attacker and compromised routers. In (4), assume that compromised routers are not adjacent. Considering the technical hurdle to subvert a router, this assumption is acceptable. In (5), it is assumed that all ingress edge routers in each AS share the BGP routing table of the BGP speaker in the same domain. This assumption indicates some additional memory on each ingress edge router to store the BGP routing table. However, this additional memory is not a big issue because the total number of ASs is only about 20,000.

In embodiments of ASEM, when an ingress edge router receives a packet, it uses the BGP routing table to conduct marking and marking examination. Assumptions (6) and (7) are supported by Internet measurements. The dominant AS path lengths are 3 to 5, with an average value of 4. Embodiments assume that an AS path length is not greater than 8, which is satisfied by about 99.5% of all AS paths.

In embodiments of ASEM, the ingress edge routers of each AS, referred to as marking routers in FIG. 1, inscribe some marking information in traversing packets in accordance with a predetermined probability. Note, in each AS, only the marking routers conduct marking and/or marking examination and all other routers will not.

The marking information inscribed on a packet by the marking routers consists of four parts in a total of 32 bits. The first part of the marking information is 16-bits long and is referred to as: AS_PATH, which stores the transformed ASPATH attribute information. The whole ASPATH attribute is stored in 16 bits. The second part of the marking information is a flag, called FALG, that tells the downstream marking router whether (FALG=“1”) or not (FALG=“0”) the current packet has been marked.

The third part of the marking information is comprised of 3 bits, which records the length of the ASPATH attribute. In ASEM, we disregard padding in calculating the length of the ASPATH attribute. That is, suppose an ASPATH is “110 2 2 2 2 317” (padding AS2), its length is still 3, same as the length of the ASPATH “110 2 317.” This length information can be used to determine the optimal marking probability, as well as for marking verification.

The fourth part of the marking information is a hash function of the IP address (HASHIP) of the first marking router along a path. HASHIP is used as linkage information so that the victim V can readily identify packets from the same sources and thus path reconstruction is significantly facilitated and the rate of false positives is reduced. Note that the procedure of path reconstruction has already been greatly simplified because the first step, recovering the 32-bit IP address of each router, is unnecessary in ASEM.

Additionally, HASHIP can be used to distinguish disparate attack sources, making it easy to tackle large-scale DDoS that are dominant in today's Internet environment. Furthermore, with HASHIP, the victim V can block attack traffic proactively rather than depending on the response of its ISPs. It should be noted that this is impossible for background art PPM schemes for IP traceback because the marking information of one router has to be segmented and transmitted in several packets.

Using the BGP routing information in ASs as marking information allows the downstream marking router to examine the correctness of the marking from its upstream neighbors (i.e., because of the attributes of ASPATH discussed above). Thus, if spoofed marking is found, the downstream marking router may filter or drop those packets with spoofed marking. Additional information regarding this method is discussed further below.

To handle falsified marking injected by the attacker, embodiments enforce a policy of NO “re-marking”. That is, all subsequent marking routers cannot re-mark any packet that has been marked by any upstream marking routers. By integrating these two approaches and using the derived optimal marking probability, embodiments minimize the number of packets required for path reconstruction and, at the same time, significantly enhance robustness and greatly suppress false positives.

Embodiments reduce the computational burden as discussed in the following paragraphs. In particular, the computational burden lies mainly in the method for path reconstruction. Therefore, reducing the total number of marked packets required for path reconstruction is therefore critical. First, embodiments attempt to find the optimal marking probability, second the marking mechanism is enhanced, and third the possibility of “reducing” the path length is studied.

Denote k as the number of attack paths to the victim v. For path j (1≦j≦k), the number of routers between the attack source and v is dⱼ. Let pⱼⁱ(m) be the marking probability of router i (1≦i≦dⱼ) along path j, and pⱼⁱ(v) be the marking probability of router i along path j perceived by v. pⱼⁱ(v) may be different from pⱼⁱ(m), e.g., for PPM pⱼⁱ(m)=p and pⱼⁱ(v)=p(1−p)^{d}^{ⱼ}⁻ⁱ.

Denote Nⱼ as the number of packets traversing along path j, and Mⱼⁱ as the number of packets marked by the i-th router along path j and received by v. In other words, those packets initially marked by the i-th router but are re-marked by any subsequent router are not counted into Mⱼⁱ. Denote Mⱼ as the number of packets marked by any router along path j and received by v. Since PPM and ASEM mark packets probabilistically, Mⱼⁱ and Mⱼ are random variables. Clearly, the expectations of Mⱼⁱ and Mⱼ are

$$\begin{matrix}E [ {M}_{j}^{i} ] = {N}_{j} {p}_{j}^{i} ( v ) , & ( 1 ) \\ and E [ {M}_{j} ] = E [ {\sum }_{i = 1}^{{d}_{j}} {M}_{j}^{i} ] = {\sum }_{i = 1}^{{d}_{j}} E [ {M}_{j}^{i} ] = {N}_{j} {\sum }_{i = 1}^{{d}_{j}} {p}_{j}^{i} ( v ) , & ( 2 )\end{matrix}$$

respectively.

It is difficult to directly compare the number of marked packets under PPM and ASEM. However, we can compare their performance given the same number of attack packets and the same attack path. Two metrics that we use are: (1) the expectation of the total number of marked packets, E[M^{j}ⁱ], and (2) the probability that the victim receives at least one marked packet from each router, P{Mⱼ¹≧1; Mⱼ²≧1; . . . ; Mⱼ^{d}^{ⱼ}≧1}.

The following paragraphs further discuss the Number of Marked Packets for Path Reconstruction. In particular, this paragraph discusses the Expected Values of the Total Number of Marked Packets along Path j. In PPM, pⱼⁱ(v)=p(1−p)^{d}^{ⱼ}⁻ⁱ. From (2) we obtain:

$$E [ {M}_{j} ] = {N}_{j} {\sum }_{i = 1}^{{d}_{j}} {p}_{j}^{i} ( v ) = {N}_{j} ( 1 - {( 1 - p )}^{{d}_{j}} ) . \qquad ( 3 )$$

The design of ASEM ensures that all packets are marked somewhere along a path. Therefore, even when an attacker sends packets with spoofed marks intentionally, those spoofed marks will be overwritten by the correct marking of the marking routers. Therefore, spoofed marking from the attacker is not an issue for ASEM. Since

$$\begin{matrix}{\sum }_{i = 1}^{{d}_{j}} {p}_{j}^{i} ( v ) = 1 , \\ for ASEM , & ( 4 ) \\ E [ {M}_{j} ] = {N}_{j} {\sum }_{i = 1}^{{d}_{j}} {p}_{j}^{i} ( v ) = {N}_{j} . & ( 5 )\end{matrix}$$

That is, given the same number of attack packets and the same path, on average, the victim can obtain more marked packets in ASEM than in PPM. Subsequently, the victim can more likely reconstruct the attack path in ASEM than in PPM.

The following paragraph discusses the probability of receiving at least one marked packet from each router. In PPM, each router conducts marking independently, therefore

P{Mⱼ¹≧1; Mⱼ²≧1; . . . ; Mⱼ^{d}^{ⱼ}≧1}=P{Mⱼ¹≧1}P{Mⱼ²≧1} . . . P{Mⱼ^{d}^{ⱼ}≧1}. (6)

### That is,

$$\begin{matrix}P \{ {M}_{j}^{1} \geq 1 ; {M}_{j}^{2} \geq 1 ; … ; {M}_{j}^{{d}_{j}} \geq 1 \} = {\prod }_{i = 1}^{{d}_{j}} ( 1 - p \{ {M}_{j}^{i} = 0 \} ) \\ = {\prod }_{i = 1}^{{d}_{j}} ( 1 - {[ 1 - {p}_{j}^{i} ( v ) ]}^{{N}_{j}} ) .\end{matrix} \qquad ( 7 )$$

### Since pⱼ¹(v)<pⱼ²(v)< . . . <pᵢ^{d}^{ⱼ}⁻¹(v),

1−[1−pⱼ¹(v)]^{N}^{ⱼ}<1−[1−pⱼ²(v)]^{N}^{ⱼ}< . . . <1−[1−pⱼ^{d}^{ⱼ}(v)]^{N}ⱼ. (8)

### Combining with (7), we obtain

P{Mⱼ¹≧1; Mⱼ²≧1; . . . ; Mⱼ^{d}^{ⱼ}≧1}<(1−[1−pⱼ^{d}^{ⱼ}(v)]^{N}^{ⱼ})^{d}^{ⱼ}=(1−[1−p]^{N}^{ⱼ})^{d}^{ⱼ}. (9)

### Inequality (9) holds for any p (0<p<1). On the other hand, the maximum value of Equation (7) can be obtained by taking the derivative of Equation (7) with respect to p, resulting in

$$p = \frac{1}{{d}_{j}} . \qquad ( 10 )$$

Thus, the maximum value of Equation (7) can be reached if Equation (10) is satisfied. Unlike PPM, the marking probability of each router with respect to the victim is the same in ASEM, i.e.,

pⱼⁱ(v)=1/dⱼ. (11)

### Following a similar derivation, for ASEM,

$$\begin{matrix}P \{ {M}_{j}^{1} \geq 1 ; {M}_{j}^{2} \geq 1 ; … ; {M}_{j}^{{d}_{j}} \geq 1 \} = {\prod }_{i = 1}^{{d}_{j}} ( 1 - {[ 1 - {p}_{j}^{i} ( v ) ]}^{{N}_{j}} ) \\ = {( 1 - {[ 1 - \frac{1}{{d}_{j}} ]}^{{N}_{j}} )}^{{d}_{j}}\end{matrix} \qquad ( 12 )$$

From Inequality (9), and Equations (10) and (12), we can draw the conclusion that given the same number of attack packets and the same path, the probability for the victim to receive at least one marked packet from each router is greater in ASEM than that in PPM.

The following paragraphs further discuss estimating the number of attack packets required for path reconstruction. In the last subsection, we study the number of marked packets and the probability for the victim to receive at least one marked packet from each router in ASEM and PPM, given the number of attack packets. Below, we further study the number of attack packets required for successful path reconstruction.

We assume that the path reconstruction can be completed as long as the victim receives at least one marked packet from each router. In this subsection, to simplify our analysis, when we discuss the number of marked packets, we refer to their expected values. Similar simplification can be found in most background art IP traceback schemes.

Given Mⱼⁱ=Nⱼpⱼⁱ(v)≧1, ∀i(1≦i≦dⱼ), (13)

in PPM, since pⱼⁱ(v) is a monotonically increasing function of i (i.e., pⱼ¹(v)<pⱼ²(v)< . . . <pᵢ^{d}^{ⱼ}⁻¹(v)), Equation (13) can be simplified to

$$\begin{matrix}{N}_{j} \geq \frac{1}{{p}_{j}^{1} ( v )} . \\ That is , & ( 14 ) \\ {N}_{j} \geq \frac{1}{{p ( 1 - p )}^{{d}_{j} - 1}} . & ( 15 )\end{matrix}$$

### For PPM, the minimum value of Nⱼ can be obtained by taking the derivative of Equation (15) with respect to p, thus resulting in

$$p = \frac{1}{{d}_{j}} .$$

### In this case, Nⱼ for PPM can be as low as

$${N}_{j} \geq \frac{{( {d}_{j} )}^{{d}_{j}}}{{( {d}_{j} - 1 )}^{{d}_{j} - 1}} . \qquad ( 16 )$$

Unlike PPM, the marking probability with respect to the victim is the same at each router in ASEM. Combining Equation (4) with Inequality (13), it is easy to see that Nⱼ can reach its minimum as long as Equation (11) holds. In this case,

Nⱼ≧dⱼ. (17)

In fact, Equation (11) always holds in ASEM, and therefore, ASEM always uses the optimal marking probability. Since Inequality (18)

$$\frac{{( {d}_{j} )}^{{d}_{j}}}{{( {d}_{j} - 1 )}^{{d}_{j} - 1}} > {d}_{j} \qquad ( 18 )$$

always holds, theoretically, the minimum number of attack packets required for path reconstruction in ASEM is less than that in PPM even both use the optimal marking probability.

The following paragraphs include further discussion on the optimal marking probability. The discussions above studied the path reconstruction from the perspective of the victim v. Now, consider the issue from the perspective of each router along the attack path. Two questions arise naturally: (1) what would the marking probability (pⱼⁱ(m)) at each router be in order to obtain the optimal pⱼⁱ(v); and (2) can the derived optimal marking probability be practically implemented at each router?

For PPM, the marking probability (pⱼ¹(m)) at each router is the same: pⱼⁱ(m)=p, ∀i(1≦i≦dⱼ). Furthermore, if each router can know in some way the path length (dⱼ) ahead of time, the router can set the marking probability to the optimal value. If this is the case, the number of packets required for path reconstruction can be reduced to the value shown in Equation (16). However, since PPM works at the IP level, no feasible method exists in the current Internet to provide the path length for each router in advance. Therefore, the derived optimal marking probability is infeasible for PPM from a practical perspective.

For embodiments of ASEM, the marking probability (pⱼⁱ(m)) at each router is not the same. Each router determines its marking probability according to its distance to the victim. For path j, the i-th router sets its marking probability to be pⱼⁱ(m)=1/(dⱼ−i+1), where (dⱼ−i+1) is the distance (path length) between the current router and v. This is feasible because the ASPATH attribute provides the exact length information. For the first router, the marking probability is 1/dⱼ; for the second router, the marking probability is 1/(dⱼ−1); etc.

However, since the policy of NO “re-marking” is imposed in ASEM, what the first router has marked cannot be re-marked by subsequent routers. Therefore, only (1−1/dⱼ)Nⱼ packets (average number) are available for the second router to mark. With respect to the victim,

$$\begin{matrix}{p}_{j}^{2} ( v ) = \frac{1}{( {d}_{j} - 2 ) + 1} \times ( 1 - \frac{1}{{d}_{j}} ) = \frac{1}{{d}_{j}} . \\ Similarly , & ( 19 ) \\ \begin{matrix}{p}_{j}^{i} ( v ) = \frac{1}{( {d}_{j} - i ) + 1} \times ( 1 - {\sum }_{s = 1}^{i - 1} {p}_{j}^{s} ( v ) ) \\ = \frac{1}{( {d}_{j} - i ) + 1} \times ( 1 - \frac{i - 1}{{d}_{j}} ) \\ = \frac{1}{{d}_{j}} .\end{matrix} & ( 20 )\end{matrix}$$

That is, each router in ASEM always marks packets using the optimal marking probability. Thus, the computational burden is minimized. Table 1 lists the average number of marked and intact (unmarked) packets at each router in background art PPM and ASEM. For simplicity, we use S to stand for Nⱼ, and p to stand for pⱼⁱ(v).

In summary, with respect to the computational burden, ASEM distinguishes from PPM in two aspects. First, the derived optimal marking probability is feasible and practically used in ASEM while it is impractical for PPM to use the optimal marking probability because of its unawareness of the whole path length. Second, even assuming that all routers in PPM always use the optimal marking probability, Inequality (18) shows that ASEM still requires less number of packets for path reconstruction.

TABLE 1
Marking procedure at each marking router for PPM and ASEM

| | | after | after | | |
|---|---|---|---|---|---|
| | | the first | the second | | after the last |
| schemes | classifications | router | router | . . . | router |
| PPM | # of marked packets | Sp | S(2p − p²) | . . . | S(1 − (1 − p)^{d}) |
| | # of intact packets | S(1 − p) | S(1 − p)² | . . . | S(1 − p)^{d} |
| | # of packets can still | S | S | . . . | S |
| | be marked | | | | |
| ASEM | # of marked packets | Sp | 2Sp | . . . | S |
| | # of intact packets | S(1 − p) | S(1 − 2p) | . . . | 0 |
| | # of packets can still | S(1 − p) | S(1 − 2p) | . . . | 0 |
| | be marked | | | | |

The following paragraphs further discuss decreasing path length. Considering Equation (17), Nⱼ in ASEM may be further reduced by decreasing the value of dⱼ. Suppose that only d′ⱼ of dⱼ(d′ⱼ<dⱼ) routers are used to recover the attack path. The smaller d′ⱼ, the smaller Nⱼ.

Nⱼ≧d′ⱼ, d′ⱼ<dⱼ. (21)

We use the AS path, which is much shorter, instead of the hop-by-hop IP path. Since only marking routers along a path conduct marking, this is equivalent to a shorter path length with respect to path reconstruction. Note that the most important information for IP traceback is the information of the first router along a path. Though ASEM is based on the AS level, it also records the information of the first router along a path, and therefore ASEM can trace attack sources efficiently.

The following paragraphs discuss robust marking. A good marking scheme shall balance between efficiency and robustness. In addition, the previous paragraphs investigated the issue of optimal marking. Here, the issue of bogus marking from the attacker and/or subverted routers is addressed.

Spoofed marking embedded by the attacker is discussed below. The attacker may effectively deter tracing by inscribing forged marking. In background art PPM schemes, with respect to v, the possibility that packets marked by the farthest router are p(1−p)^{d}^{ⱼ}⁻¹ along path j. Let qⱼ be the probability that a packet has never been marked by any router along path j,

qⱼ=(1−p)^{d}^{ⱼ}. (22)

Clearly, if p<0.5, qⱼ>pⱼ¹(v)=p(1−p)^{d}^{ⱼ}¹. That is, the attacker may confuse v by filling bogus information on the unmarked packets so that v cannot locate the farthest router of each path. Even worse, the negative impact of spoofed marking is not limited to the farthest routers, i.e., the routers closest to the attack sources. For the average path length of 15, the optimal marking probability is p=0.0667. Thus, qⱼ=0.3553. Note that even for the closest router to v, pⱼ¹⁵(v)=0.0667<qⱼ, letting alone any other farther routers (recall that pⱼ¹(v) is a monotonically increasing function of i in PPM). This example shows how easy it is to disguise the victim v if the attacker embeds bogus marking information in PPM. However, with our NO “re-marking” strategy and the derived optimal marking probability p=1/((dⱼ−i)+1), this is not an issue any longer in ASEM because qⱼ becomes 0.

Spoofed marking caused by subverted routers is discussed below. Another source of bogus marking is the subverted routers. Up to now, few works in the background art explored this problem. Authentication is one method that has been suggested in the background art in an attempt to ensure secure marking. In contrast, embodiments of ASEM will attempt to tackle this problem by a simpler method.

As discussed above, use of BGP routing allows a downstream marking router R_{b} of AS_{b} to examine the correctness of the marking embedded by its adjacent upstream marking router Rₐ of ASₐ because the ASPATH attribute of Rₐ shall be the concatenation of the ASN of R_{b} and the ASPATH attribute of R_{b}. If a mismatch is found, the downstream marking routers can filter or drop those packets with spoofed marking. Subsequently, if the ASPATH attribute is used as the marking information at each AS, the marking router at AS_{b} can then check the correctness of the marking information from the marking router of its upstream neighbor ASₐ.

The effectiveness to large-scale DDoS attacks is discussed below. Background art schemes for PPM are ineffective to large-scale DDoS attacks. This is originated from the insufficient number of bits for marking in the IP header. As mentioned above, two steps are required for path reconstruction in PPM. One is the recovery of the complete IP address of each router, and another is the recovery of each full path. The performance of the first step may be seriously degraded because many routers may have the same distances to the victim and there exists no hint for packets from the same router to combine into a complete IP address. Similarly, no clue for packets from the same sources is presented for the victim to reconstruct a path effectively.

Embodiments of the invention implement the idea of using “linkage” information to identify packets from the same router. Note that only one step is required for path reconstruction in ASEM, and that only packets with the same linkage may be combined into a full path.

In particular, embodiments of ASEM use the next 16 bits of the ID field (i.e., the 3-bit Fragment Flag field+13-bit Fragment Offset field) in the IP header to store the linkage information. These two fields were originally designed to handle fragmented traffic that is very rare in today's Internet (about 0.25% of all traffic).

To ensure the success of reassembling at the destination, all fragments bear the same ID. In embodiments of ASEM, keeping the Fragment Flags and Fragment Offset fields unchanged is meaningless when the ID field has been used for marking in IP traceback. As mentioned above, the “No re-marking” flag occupies the 1^{st} bit of the Fragment Flag field, which is the reserved bit with the default value of 0. The next 3 bits is used to record the length of the AS path.

Embodiments of ASEM use a hash function to map the 32-bit IP address of the first router to 12-bit hash value, called HASHIP. Using this field as the guide, ASEM is very effective in determining the packets from the same sources. In so doing, ASEM may tackle large-scale DDoS attacks that are dominant today.

The following are the merits of using the HASHIP field:
(1) Using HASHIP as the guide, the path reconstruction procedure is significantly simplified because blind combinations of nodes to recover a path are effectively avoided.
(2) The HASHIP field alone may be used as the identifier for the victim to block attack traffic, which is infeasible for PPM (and most other schemes) because the marking information of a router in PPM is segmented and transmitted in several packets.
(3) With the help of HASHIP and AS_PATH, ASEM may be used to tackle large-scale DDoS attacks. AS_PATH may be used to differentiate attack flows traversing different ASs; HASHIP is used to distinguish attack flows launched from different sources at the same AS, thus facilitating ASEM to address large-scale DDoS attacks.
(4) After determining the AS path that the attack packets have traversed, the system administrator of the first AS along the attack path can identify the ingress edge router from which attack packets emitted as long as the number of the ingress edge routers in the AS in less than 4096 (2¹², we here suppose that an ideal hash function is used).

For PPM, even the victim can reconstruct the IP address of the ingress edge router along a path, it still requires the system administrator of the corresponding AS to take action because the victim is not entitled to manage that router. Therefore, telling the corresponding system administrator the full IP address of the ingress edge router or HASHIP is equivalent because the system administrator can keep a lookup table to determine the IP address from the HASHIP value.

The following paragraphs discuss the Marking Algorithms. The marking and path reconstruction algorithm is very similar to that of PPM. One difference is that the linkage information in ASEM avoids blind combination in the recovery of each attack path, thus making path reconstruction fast and efficient. Here, we present the marking algorithm only because our marking algorithm performs an additional job, marking verification.

The marking algorithms are further divided into the one for the first marking router as shown in FIG. 3, and another for other marking routers (shown in FIG. 4). Thus, if a marking router receives a packet from the same AS, it is the first marking router. On the contrary, if a marking router gets packets from other AS, it is not the first marking router. For the first marking router, it is important to check the value of the FLAG field because a sophisticated attacker may pre-set this field to 1 to block any further marking. For all other marking router, they need to check the AS_PATH field to address forged marking.

Experimental results for the performance analysis of embodiments of ASEM are discussed in the following paragraphs. In the following, the computational burden will be discussed. A comparison of the computational burden of ASEM with that of PPM from two aspects, with and without considering practical path length distribution is provided.

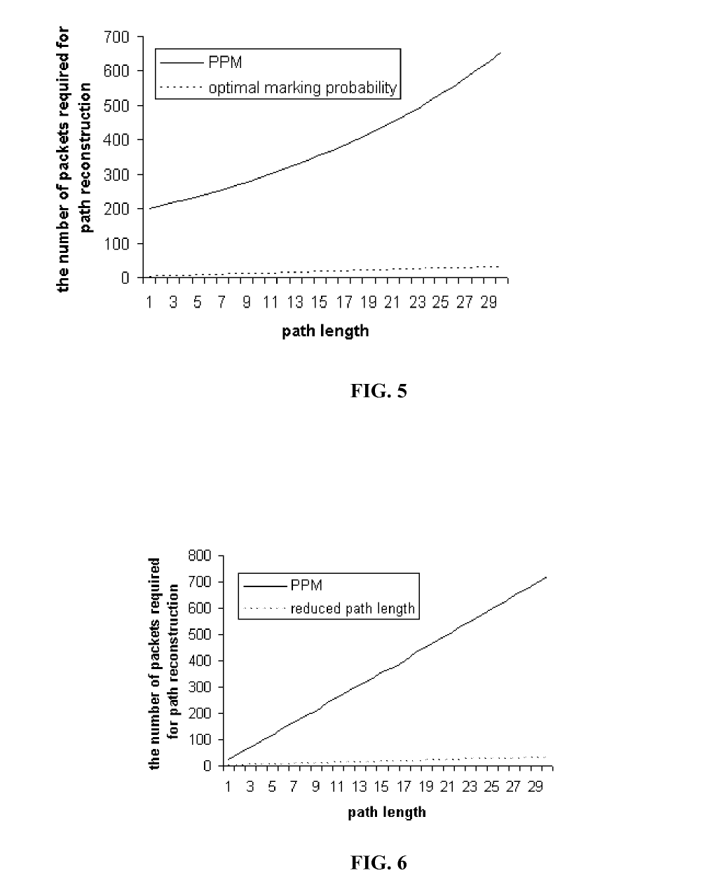

This paragraph discusses a performance comparison under different path lengths without considering real path length distribution. In PPM, routers are not cognizant of each path length ahead of time. To simplify the analysis, assume that PPM will use the recommended marking probability, 0.04. The experimental results will first show the effectiveness of each single advantage provided by embodiments, and then show the synergic effect. Note that Nⱼ shown in FIG. 5 to FIG. 7 and the results in Table 2 to Table 3 are rounded up to the nearest larger integer, i.e., ┌Nⱼ┐.

This paragraph discusses optimal marking probability. The first advantage of ASEM over the background art is achieved by using the optimal marking probability, as shown in Equation (11).

The value of Nⱼ with PPM can be obtained by substituting p=0.04 into (15). For our first advantage of ASEM, the value of Nⱼ is computed by using Equation (17). The result is shown in FIG. 5.

Shorter path length is discussed in the following. FIG. 6 demonstrates the advantage of our second advantage of ASEM over PPM. Note that ASEM and PPM work at different granularity. Even for the same path, the value of path length is different for PPM and our approach because ASEM works at the AS level and only marking routers along each path are allowed to perform marking. Thus, ASEM has a “shorter” path length. According to the recent Internet measurement, on average the path length at the IP level is about 3 times the corresponding path length at the AS level. Hence, for simplicity, we only consider those IP paths with path length 6, 9, 12, . . . , 30, corresponding to path length of 2, 3, 4, . . . , 10 at the AS level. The simplification will be used whenever a comparison involves our advantage 2.

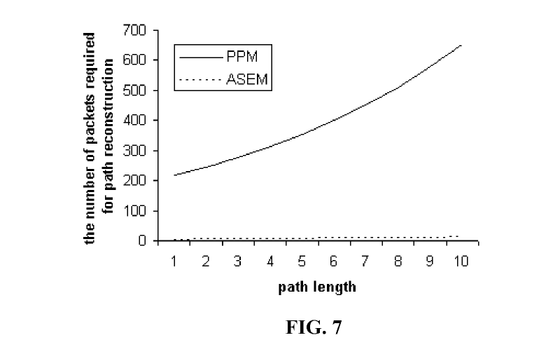

Integrating both advantages into the embodiment of ASEM, the final result are shown in FIG. 7. From the figure, it is obvious that the embodiments of ASEM outperform PPM significantly.

A performance comparison considering real path length distribution is discussed below. Taking the practical path length distribution into account, a more accurate picture of the performance of ASEM can be obtained.

We have two datasets. One is from the Skitter project of CAIDA, and another is the Internet Mapping data from Lumeta, as referenced at Internet Mapping Project, available from http://research.lumeta.com/ches/map/ and CAIDA, Skitter, available from http://www.caida.org/tools/measurement/skitter/, respectively. The analysis results were obtained by simply averaging the number of paths from both datasets for each path length, and using the result as our dataset. Since a vast majority of IP path lengths fall in the range of (6, 30) inclusively, one can discard all paths whose lengths are out of this range. A total of 9804 paths from the rest of our dataset were selected. Among the 9804 paths, 3448 paths, which have IP path lengths of 6, 9, 12, . . . , or 30, will be used for comparisons involving our second improvement.

To reconstruct all 9804 paths (denoted as set S₁), consider two related parameters: (1) the total number of packets required to reconstruct all paths, N; and (2) the average number of packets required to reconstruct a path, n. Similarly, for the selected 3448 paths (denoted as set S₂), N′ and n′ are used to represent the total number of packets required to reconstruct all paths and a path on average, respectively.

N, N′, n, and n′ are computed according to Equations (23), (24), (25), and (26), respectively. The results are shown in Table 2 and Table 3 below.

$$\begin{matrix}N = {\sum }_{j ∈ {S}_{1}} {N}_{j} . & ( 23 ) \\ {N}^{′} = {\sum }_{j ∈ {S}_{2}} {N}_{j} . & ( 24 ) \\ n = \frac{N}{9804} . & ( 25 ) \\ {n}^{′} = \frac{{N}^{′}}{3448} . & ( 26 )\end{matrix}$$

In Table 2, as explained before, we use only those IP paths whose lengths are multiples of 3 and in the range of (6,30) inclusive. Note that the approximation does not seem to affect the result much. Considering PPM, on average, the numbers of marked packets required for reconstructing a path from 9804 paths and 3448 paths are 544 and 520, respectively. These two values are very close (the difference is only 4.41%). With ASEM, a saving of 98.85% on average of the total number of packets required for reconstructing a path may be achieved.

Robustness of the embodiments is discussed in the following. ASEM can address spoofed marking from the attacker and subverted routers. For PPM, the possibility that a packet reaches the victim untouched (i.e., unmarked) is (1−p)^{d}^{ⱼ} along path j. To totally confuse the victim, the following inequality shall be satisfied,

qⱼ=(1−p)^{d}^{ⱼ}≧Σ₁^{d}^{ⱼ}pⱼⁱ(v). (27)

In this case: p≦1−2^{(-1/d}^{ⱼ}⁾. (28)

TABLE 2
N and n under PPM, our Advantage 1 of ASEM

| | PPM | Advantage 1 of ASEM |
|---|---|---|
| Total (N) | 5,383,968 | 156,687 |
| Average (n) | 544 | 16 |

TABLE 3
N′ and n′ under PPM, our Advantage 2, and both Advantages
1-2

| | PPM | Advantage 2 | Advantages 1-2 |
|---|---|---|---|
| Total(N′) | 1,789,336 | 30,986 | 20,511 |
| Average (n′) | 520 | 9 | 6 |

For the average path length of 15 Equation (28) holds if p≦0.04516. Therefore, using the recommended value p=0.04 will seriously impede reconstruction and invoke high false positives. In ASEM, on the contrary, qⱼ=0. In other words, even all packets mounted by the attacker are inscribed with spurious marking, such bogus marking information will be totally overridden by correct marking information from routers as packets traverse along the attack path. Therefore, with this advantage of ASEM, we eradicate spoofed marking from the attacker while optimizing Nⱼ.

For subverted routers, ASEM thwarts their adverse impacts by examining the correctness of marking information. In comparison with background art schemes using authentication, ASEM introduces far less overhead.

The performance of embodiments of ASEM for false positives is discussed in the following. In particular, less marking bits, as compared with the background art, are possible with embodiments of ASEM.

One reason for high false positives is the insufficient marking bits. In PPM, the victim has to combine packets with 8 fragments to determine a 32-bit IP address while this step is not necessary in ASEM. Furthermore, the marking information for one router in ASEM is 16-bit, only half of that required in PPM. Therefore, false positives incurred by combinatorial explosion are mitigated significantly by both factors.

Linkage information is discussed in the following. The linkage information in ASEM can effectively avoid blind combinations in path reconstruction. This is very important especially in large-scale DDoS attacks, which are the dominant attack pattern today. The 12-bit linkage information can be used as a guide in path reconstruction.

Reduced path lengths are discussed in the following. Note also the “avalanche” effect of false positives caused by routers closer to the victim. During path reconstruction, if a router R that is h hops away from the victim is added to the attack path by mistake, then this will affect locating routers h+1 hops away. The smaller h, the higher false positives. In general, the decrement in path length can reduce false positives exponentially, thus favoring the ASEM method.

Embodiments provide a robust and optimal marking scheme for IP traceback. First, embodiments provide a metric for the optimization of path reconstruction. Note that path reconstruction is the fundamental goal of packet marking. Using this metric as the guideline, two advantages of ASEM over the background art have been presented above. By integrating both advantages it can be seen that ASEM possesses a number of additional advantages over the background art. First, optimal marking probability: previous paragraphs derived the optimal marking probability, and presented a practical implementation. In comparison with legacy PPM, as many as 98.85% of marked packets can be reduced on average. Second, robust marking: ASEM can handle not only spoofed marking by the attacker, but also the phony marking incurred by subverted routers. Third, effectiveness to handle large-scale DDoS attacks which are dominant in today's Internet environment. Fourth, reduced false positives: high false positives are effectively suppressed due to the above advantages. Fifth, partial Deployment. Sixth, the power-law Internet facilitates effective partial deployment of ASEM.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive. For example, a display may be employed to display one or more queries, such as those that may be interrelated, and or one or more tree expressions, although, again, claimed subject matter is not limited in scope to this example. Likewise, an embodiment may be implemented as a system, or as any combination of components such as computer systems, mobile and/or other types of communication systems and other well known electronic systems.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A method for Internet Protocol (IP) traceback, comprising:
receiving one or more packets at routers;
inscribing packets only at marking routers at an autonomous system (AS) level with marking information; and
forwarding marked packets to edge routers and other routers for verification,
wherein the packets are marked based on a probability measure and
wherein Border Gateway Protocol (BGP) routing table information is the AS level information used for marking and verification.

2. The method for IP traceback of claim 1, wherein the probability measure is determined by whether a random number is less than an optimal marking probability.

3. The method for IP traceback of claim 2, wherein BGP routing table information is used for marking and verification. is autonomous system numbers (ASN) and ASPATH attributes.

4. The method for IP traceback of claim 3, wherein the BGP routing table information used for marking and verification further comprises at least one of autonomous system numbers (ASN) and ASPATH attributes.

5. The method for IP traceback of claim 4, wherein marking information further comprises a flag identifying marked packets; a path length attribute; and a hash function of the IP address of the marking router.

6. The method for IP traceback of claim 5, wherein verification further comprises comparing upstream and downstream marking information to confirm that an only difference between upstream and downstream marking information is the ASN of the upstream router.

7. A processor-readable medium containing software code that, when executed by a processor, causes the processor to implement a method for IP traceback comprising:
receiving one or more packets at routers;
inscribing packets only at marking routers at an autonomous system (AS) level with marking information; and
forwarding marked packets to edge routers and other routers for verification,
wherein the packets are marked based on a probability measure and
wherein Border Gateway Protocol (BGP) routing table information is the AS level information used to for marking and verification.

8. The processor readable medium of claim 7, wherein the probability measure is determined by whether a random number is less than an optimal marking probability.

9. The processor readable medium of claim 8, wherein BGP routing table information is used for marking and verification. is autonomous system numbers (ASN) and ASPATH attributes.

10. The processor readable medium of claim 9, wherein the BGP routing table information used for marking and verification further comprises at least one of autonomous system numbers (ASN) and ASPATH attributes.

11. The processor readable medium of claim 10, wherein marking information further comprises a flag identifying marked packets; a path length attribute; and a hash function of the IP address of the marking router.

12. The processor readable medium of claim 11, wherein verification further comprises comparing upstream and downstream marking information to confirm that an only difference between upstream and downstream marking information is the ASN of the upstream router.

13. The processor readable medium of claim 12, wherein subverted routers and compromised routers are not adjacent.

14. The processor readable medium of claim 13, wherein an attack is at least composed of tens of packet.

15. A system for IP traceback, comprising:
a plurality of autonomous systems;
routers configured to interconnect the plurality of autonomous systems, wherein the routers further comprise:
marking routers configured to mark packets received by the plurality of autonomous systems; and
edge routers and other routers interconnected to the marking routers and configured to verify packets marked by the marking routers,
wherein the marking routers, edge routers and other routers further comprise processors configured to execute the software readable medium of claim 7.

16. The system of claim 15, wherein BGP routing table information is used for marking and verification. is autonomous system numbers (ASN) and ASPATH attributes.

17. The system of claim 16, wherein the BGP routing table information used for marking and verification further comprises at least one of autonomous system numbers (ASN) and ASPATH attributes.

18. The system of claim 17, wherein marking information further comprises a flag identifying marked packets; a path length attribute; and a hash function of the IP address of the marking router.

19. The system of claim 18, wherein verification further comprises comparing upstream and downstream marking information to confirm that an only difference between upstream and downstream marking information is the ASN of the upstream router.

20. The system of claim 19, wherein subverted routers and compromised routers are not adjacent, and wherein an attack is at least composed of tens of packets.
